(19) United States
(12) Patent Application Publication
(10) Pub. No.: US 2026/0133062 A1
(43) Pub. Date: May 14, 2026

(54) Filling level measuring device

(71) Applicant: SICK AG, Waldkirch (DE)

(72) Inventors: Boris BALDISCHWEILER, Reute (DE); Thomas WEBER, Seelbach (DE)

(21) Appl. No.: 19/384,385

(22) Filed: Nov. 10, 2025

(30) Foreign Application Priority Data
Nov. 11, 2024 (EP) 24212191.1

(51) Int. Cl. G01F 23/22

(52) U.S. Cl. CPC G01F 23/22

(57) ABSTRACT

The invention relates to a filling level measuring device for determining a filling level of a medium in a container, said filling level measuring device comprising a signal generating device that is configured to generate an electrical signal that comprises a step function or a pulse function; a measuring line that is connected, in particular electrically connected, to the signal generating device and that extends from a process connection up to and into the medium, wherein the measuring line serves to conduct the electrical signal into the container and towards the medium, wherein the electrical signal is at least partly reflected at the surface of the medium and the reflected signal influences the electrical signal; and an evaluation unit that is configured to determine the filling level of the medium based on the influenced electrical signal.

The present invention relates to a filling level measuring device for determining a filling level of a medium in a container.

The precise determination of the filling level in tanks is a frequent requirement in various industrial applications. In this respect, different technologies are available to solve this problem. Optical, radar-based, capacitive or conductive sensors, tuning forks, floats or wired TOF (time-of-flight) methods can be used to measure the filling level, for example.

In wired TOF methods, an electrical pulse is sent through a cable that extends into the liquid of the tank. Since the cable has different effective impedances for the section that does not extend into the liquid and for the section that extends into the liquid, the electrical pulse transmitted through the cable is reflected at the liquid surface, i.e. at the boundary between the two different impedances, wherein the filling level of the tank can be inferred based on the time of flight of the electrical pulse from a process connection towards the surface of the liquid and the time of flight of the reflected signal from the surface of the liquid back to the process connection.

However, the evaluation of the pulse in the wired TOF method places high demands on the transmission and reception devices since they have to provide high resolutions, often down to the picosecond range, which increases the complexity and costs. A further disadvantage is that many excitation signals are often required in succession to record the time of flight, which has a negative effect on the energy consumption. Furthermore, the existing methods lead to a high emission of high-frequency interference since portions of the high-frequency pulse signal can radiate through the measuring probe acting as an antenna. Such applications are therefore often limited to the use in metal containers.

It is an object of the present invention to remedy the above disadvantages and to provide an improved filling level measuring device for determining a filling level of a medium in a container and a corresponding method.

This object is satisfied by the subjects of the independent claims.

A first aspect of the invention relates to a filling level measuring device for determining a filling level of a medium in a container, said filling level measuring device comprising:
a signal generating device that is configured to generate an electrical signal that comprises a step function or a pulse function;
a measuring line that is connected, in particular electrically connected, to the signal generating device and that extends or can extend from a process connection up to and into the medium, wherein the measuring line serves to
conduct the electrical signal into the container and towards the medium, wherein the electrical signal is preferably at least partly reflected at the surface of the medium and the reflected signal influences the electrical signal; and
an evaluation unit that is configured to determine the filling level of the medium based on the influenced electrical signal.

The invention is thus based on the realization that the reflection of the electrical signal at the medium surface influences or changes the original electrical signal and that this change is reflected in the form of the influenced electrical signal so that the time of flight of the electrical signal, and thus the filling level of the medium, can be determined based on the influenced electrical signal, in particular indirectly. In particular, the filling level of the medium is thus determined without a direct measurement or determination of the time of flight of the electrical signal up to the medium surface and back (time of flight). The influenced electrical signal is in particular the step response or pulse response of the system to the applied input signal.

When the time of flight of the electrical signal is mentioned herein, it refers—unless otherwise stated—to the time of flight of the electrical signal from the process connection (or from the signal generating device) towards the surface of the medium and to the time of flight of the reflected signal from the surface of the medium back to the process connection (and thus to the evaluation unit).

The signal generating device is, for example, a voltage source that generates a voltage, which at least partly has the form of a step function or pulse function, and feeds it into the filling level measuring device. In particular, the signal generating device is capable of switching on the electrical signal quickly or feeding it into the system, i.e. with a rise time that is shorter than 10 ns, than 1 ns or than 100 ps. It is hereby, for example, ensured that the filling level measuring device is able to carry out measurements with an appropriate measuring accuracy and resolution. A rapid increase in the electrical signal can, for example, also be generated by “abruptly” feeding a constant electrical signal into the system by switching a switch. For example, the switch can be configured as part of the signal generating device and can switch the electrical signal on and off. In other words, the switch connects the signal generated by the signal generating device to a remaining part of the filling level measuring device and disconnects it again so that a corresponding electrical signal is generated.

The electrical signal or the voltage is in particular applied to the measuring line or transmitted via the measuring line. The measuring line can in this respect be any suitable line, in particular a cable, that is capable of transmitting electrical signals, wherein the measuring line has a corresponding measuring line impedance that in particular depends on the permittivity of the surrounding medium. For example, the measuring line can also comprise a plurality of connected metal parts that are electrically connected to a metal probe projecting into the medium. The metal parts can e.g. be integrated into a wall of the container or arranged spaced apart from the wall.

The impedance of the measuring line can further depend on the geometry that is preferably assumed to be constant herein. The impedance of the measuring line can be described as the characteristic impedance of the transmission path, e.g. of a cable, in dependence on the surrounding material properties along this path. It can change if the medium—and in particular the permittivity—in which the signal propagates changes, for instance, on a change from air to a liquid medium. The electrical signal is conducted, starting from the process connection, towards the medium via the measuring line. The measuring line is preferably electrically insulated from both the process connection and the medium. The process connection is, for example, a mechanical interface via which the filling level measuring device is securely and tightly mounted at the container and via which the measuring line is connected to the remaining part of the filling level measuring device. The electrical signal thus travels along the measuring line towards the medium. Since the measuring line impedance within the medium typically differs from the measuring line impedance outside the medium, an impedance jump takes place on the transmission of the electrical signal at the medium surface, i.e. the interface between the medium and air or at the point at which the measuring line penetrates the medium surface. This change in impedance causes a reflection of the electrical signal at the medium surface, wherein the reflected signal influences the original electrical signal. In the following, the impedance of the measuring line for the section that extends into the medium is referred to as the medium impedance, while the impedance of the measuring line for the section that does not reach into the medium is referred to as the reference impedance. The strength of the reflection in particular depends on the impedance difference between the reference impedance and the medium impedance. A greater impedance difference leads to a correspondingly stronger reflection. In particular, the reflected signal is superposed on the originally generated electrical signal, whereby the original electrical signal can be attenuated or amplified. An amplification is expressed, for example, in that the amplitude of the electrical signal increases, wherein an attenuation is expressed in that the amplitude of the electrical signal becomes smaller. An attenuation of the electrical signal in particular takes place if the reference impedance is greater than the medium impedance. Accordingly, an amplification of the electrical signal in particular takes place if the reference impedance is smaller than the medium impedance. In particular, due to the reflection, a superposition of the reflection with the excitation signal, i.e. the electrical signal, takes place, wherein the reflection has the same or the reverse polarity of the excitation signal depending on the nature of the impedance change and is superposed accordingly.

The reflected signal thus changes the original electrical signal, in particular the amplitude of the original electrical signal. The point in time of this change in the changed or influenced electrical signal can thus be used to determine, at least indirectly, the time of flight of the electrical signal and thus the filling level of the medium. Since the strength of the reflection, and thus the effect of the reflected signal on the electrical signal, depends on the impedance difference between the reference impedance and the medium impedance, the reference impedance can be defined in dependence on the medium impedance that depends on the known medium. The reference impedance can in particular be defined such that as strong as possible a reflection of the electrical signal at the medium surface is achieved in order to facilitate the detection of the resulting change in the electrical signal.

The evaluation unit is thus able to determine the filling level of the medium based on the influenced electrical signal. The evaluation unit in particular serves to process and analyze signals such as the influenced voltage signal, in particular in real time. In this respect, the evaluation unit can process both analog and digital signals. In addition, various calculations or comparisons can be carried out using predefined algorithms or stored sets of rules in order to recognize deviations, make decisions or send further control commands to other system components. The evaluation unit can thus also be configured as a control and evaluation unit. For example, the evaluation unit can comprise a microcontroller, a digital signal processor (DSP), a programmable logic controller (PLC) or a computer. By integrating storage and processing functions, the evaluation unit can furthermore store data and make the data available for analysis.

Advantageously, the variable times of flight in the electronics of the filling level measuring device have no influence on the determination of the filling level or the time of flight since, according to the invention, the filling level is determined on the basis of the influenced electrical signal, wherein the first edge of the electrical signal represents the start time and the reflected signal influences the electrical signal such that the point in time of the change can be evaluated as the end of the time of flight measurement. A further advantage of the invention is that a filling level determination can take place with considerably fewer transmission pulses than according to the prior art. In the simplest case, the filling level determination according to the invention can be determined by means of a single transmission pulse. On the one hand, this leads to an improvement in the energy consumption of the filling level measuring device and to a reduction of emissions caused by the sensor, whereby regulatory requirements regarding the EMC compatibility can be met so that a use of the filling level measuring device is also possible without using a metallic container. Furthermore, fast response times are realized by a filling level measuring device according to the invention. In contrast to conventional wired TOF methods, the filling level measuring device according to the invention is easier and cheaper to implement. The filling level measuring device according to the invention is in particular suitable for measuring greater depths with an accuracy of 1 to 10 cm. For example, the water level can be measured at shipping locks or reservoirs. However, more compact applications in a rainwater storage system or for measuring the cooling water level in an engine compartment are also possible.

Further embodiments of the invention can be seen from the description, from the dependent claims and from the drawings.

According to one embodiment, the evaluation unit is configured to determine a substitution variable based on the influenced electrical signal, said substitution variable being proportional to a time of flight of the electrical signal from the process connection towards the medium surface and back and/or to a distance between the medium surface and the process connection, and to determine the filling level of the medium based on the substitution variable, wherein the substitution variable preferably does not correspond to the time of flight of the electrical signal. The substitution variable can be a variable different from the time of flight of the electrical signal. Thus, the substitution variable can be used instead of the time of flight of the electrical signal to determine the filling level of the medium. Based on the substitution variable, the time of flight of the electrical signal can, however, be determined, in particular indirectly, and the filling level of the medium can thus be inferred. The substitution variable can, for example, be a voltage value derived from the influenced electrical signal or determined based on the influenced electrical signal. The determined value or magnitude of the substitution variable, for example a measured voltage value, can subsequently be assigned to a filling level value, which can then be defined as the determined filling level of the medium, by means of an allocation table or in another suitable way. In particular, the allocation table can have been empirically determined in advance or calculated based on the known system properties.

According to a first embodiment, the influenced electrical signal has a pulse shape, wherein the evaluation unit is configured to generate a square wave signal based on a pulse width of a pulse, in particular a first pulse, of the influenced electrical signal, the width of said square wave signal substantially corresponding to the pulse width of the influenced electrical signal, and to determine the substitution variable based on the square wave signal. As already described above, the reflected signal has an effect on the electrical signal and in particular causes a drop in the amplitude of the electrical signal. The influenced electrical signal thus has a pulse shape that is at least characterized by a rising edge when generating the electrical signal and by a falling edge when receiving the reflected signal. The pulse width in particular corresponds to the time of flight of the electrical signal from the process connection up to the medium surface and back.

Based on the influenced electrical signal, a square wave signal, in particular an electrical square wave signal, can be generated, whose rising edge indicates the application of the electrical signal and whose falling edge indicates the detection of the reflected signal. In other words, the influenced electrical signal is converted into a square wave signal that only represents a width of the first pulse. The width of the square wave signal thus corresponds exactly to the time of flight of the electrical signal from the process connection to the medium surface and back. The square wave signal in particular contains the time of flight information required to determine the filling level of the medium. Instead of extracting this time of flight information in a time-consuming and cost-intensive manner by means of a corresponding ADC, the square wave signal can be used to determine the substitution variable via which the filling level can be determined in a simpler manner.

According to one embodiment, the evaluation unit is configured, using a threshold value filter, to generate the square wave signal on the basis of the influenced electrical signal, wherein the square wave signal substantially assumes the value 0 if the influenced electrical signal is smaller than a predefined threshold value and assumes a predefined value not equal to 0 if the influenced electrical signal is greater than the predefined threshold value, wherein the evaluation unit is configured to carry out an integration of the square wave signal using an integrator component in order to determine an integration value, and to determine the filling level of the medium based on the integration value. The square wave signal in this respect only has the predefined value if the influenced electrical signal is greater than the predefined threshold value so that it is ensured that only the time range that lies before a drop caused by the reflected signal and after an initial increase in the electrical signal is recorded. In particular, the predefined threshold value is selected such that the predefined threshold value is greater than a signal amplitude after a drop in the influenced electrical signal caused by the reflected signal.

To determine the filling level of the medium, the substitution variable that is proportional to the time of flight of the electrical signal, and thus to the distance to be determined, can then be determined instead of the time of flight of the electrical signal. For this purpose, the evaluation unit is configured to perform an integration of the square wave signal using the integrator component in order to determine an integration value that is proportional to the time of flight of the electrical signal. The filling level of the medium can then be determined based on the integration value. In this case, the integration value is used as a substitution variable.

The threshold value filter can, for example, comprise a comparator, a diode or a digital gate. The integrator component can further comprise a capacitor and/or an operational amplifier. In the following, the mode of operation of the filling level measuring device is explained purely by way of example for the use of a comparator as a threshold filter and a capacitor as an integrator component, wherein the statements also apply accordingly to a diode or an operational amplifier.

As soon as the comparator receives the influenced electrical signal as a voltage signal, it compares the influenced voltage signal, for example, with a predefined reference voltage, which corresponds to the predefined threshold value, and outputs the square wave signal described above that is in particular likewise a voltage signal. Based on the square wave signal, a current source can then be controlled that charges the capacitor. The capacitor is thus in particular only charged for the time period in which the square wave signal has a value other than zero. In other words, the capacitor is charged for a duration corresponding to the time of flight. The voltage drop across the capacitor is thus in particular proportional to the time of flight of the electrical signal. The voltage drop across the capacitor can then, for example, be sampled or measured by means of an ADC and the filling level of the medium can be concluded based on the determined voltage value of the capacitor. In particular, the measured voltage value can, using an allocation table, be assigned an associated filling level value that can be defined as the determined filling level value. The determination of the filling level of the medium thus in particular takes place based on a measurement of a capacitor voltage. The pulse width and thus the time of flight of the electrical signal can be determined indirectly or directly on the basis of the voltage measurement. The evaluation unit can further be configured to discharge the capacitor, in particular completely, until a next measurement using a discharge circuit or a resistor connected in parallel with the capacitor.

According to one embodiment, the evaluation unit is configured to define the predefined threshold value in dependence on the impedance difference between a reference impedance, which represents the impedance of the measuring line for the section that does not extend into the medium, and a medium impedance that represents the impedance of the measuring line for the section that extends into the medium. This in particular follows from the fact that the strength of the reflection of the electrical signal, and thus of the influencing of the electrical signal by the reflected signal, depends on the impedance difference between the medium impedance and the reference impedance. If the effect of the reflected signal on the signal amplitude of the electrical signal, i.e. the level of the drop of the electrical signal due to the reflected signal, which level is defined by the filling level of the impedance difference, is known, the threshold value can be set accordingly so that the square wave signal captures or simulates the corresponding rising and falling edge of the influenced electrical signal as precisely as possible. In this respect, the predefined threshold value must in particular be defined so that the predefined threshold value is greater than the signal amplitude of the influenced electrical signal after a drop caused by the reflected signal. It is hereby in particular ensured that signal values after the drop are left out of consideration for the determination of the width of the square wave signal.

According to one embodiment, the evaluation unit is configured to adjust, in particular to reduce, the predefined threshold value of the threshold value filter continuously or at predefined time intervals. The predefined threshold value can thus be a variable threshold value. By changing the threshold value, a development of the influenced electrical signal can be determined and a plurality of reflection points can be recognized based on the determined development. In such a case, for example, a plurality of electrical signals could be generated successively via the signal generating device, wherein a respective different predefined threshold value is set for each of the generated electrical signals. In this case, a deterioration in the response time of the filling level measuring device could thus be deliberately accepted in order to detect a plurality of reflection points.

According to one embodiment, the evaluation unit comprises a plurality of threshold value filters with different threshold values, in particular to detect a sequence of different reflected signals. The electrical signal can, for example, be reflected at different points of the medium surface so that a plurality of different reflected signals are generated. However, a plurality of media can also be present within the container so that the electrical signal is reflected at the surface of the respective medium and a respective reflected signal is generated. For example, a first medium and a second medium can be present in the container, wherein the first medium has a lower density than the second medium so that the first medium “floats” on the second medium. The first medium and the second medium can have different impedances so that a strength of the reflection of the electrical signal is different for the two media, which can in turn be recognized in the influenced electrical signal.

The filling level measuring device is thus in particular multi-echo capable, i.e. able to recognize and to process a plurality of reflections or echoes from a single electrical signal or pulse. As already described, one advantage of a multi-echo system is that a plurality of reflections from different surfaces or materials within a container can be detected. This enables the recording of information about different filling levels or layer boundaries within a single measuring process or within a plurality of consecutive measuring processes. Furthermore, the reliability of the filling level measurement can be improved by detecting a plurality of reflected signals since the additional information can be used to obtain a more precise measurement. Additionally or alternatively, a number of the media can be determined in a first step and the comparator can then be set in a second step so that only the distance from a selected medium is measured.

According to one embodiment, the evaluation unit is configured to sample an integration signal, which is generated by the integration of the square wave signal, by means of an analog-to-digital converter (ADC) with a sampling frequency of less than 10 MHz, less than 1 MHz, less than 100 kHz, less than 10 kHz or less than 1 kHz in order to determine the integration value. If the integration of the square wave signal, for example, takes place by means of a capacitor by charging the capacitor for a predefined time period that corresponds to the width of the square wave signal, the voltage drop across the capacitor can, for example, be sampled by means of an ADC to determine the corresponding voltage value that is proportional to the time of flight of the electrical signal. The ADC can in particular be integrated into a microcontroller or a “System On Chip” (SOC).

Advantageously, the determination of the filling level thus does not take place by using expensive and energy-intensive evaluation components, but can rather be carried out by means of simple ADCs on which reduced demands can be placed due to the simplicity of the signal. This is in particular due to the fact that no direct time-resolving methods are used to determine the filling level.

According to one embodiment, the measuring line comprises a coaxial cable. Coaxial cables have the advantage that they have a defined characteristic basic impedance that is typically between 50 and 75 ohms and that is constant along the entire cable length. This is important for the determination of the filling level since the reflected signal is not influenced by the characteristic properties of the measuring line and thus depends mainly on the impedance difference between the reference impedance and the medium impedance. In other words, the constant basic impedance of the coaxial cable ensures that no additional reflections occur due to fluctuations in the basic impedance. The basic impedance is, for example, the impedance of an electrical component without the influence of the surrounding medium, e.g. in an ideal vacuum or an empty space. A further advantage of coaxial cables is that the signal is protected from electromagnetic interference (EMC). Due to the constant properties of the coaxial cable, a precise and reliable transmission of the electrical signal and the reflected signal is thus ensured.

According to one embodiment, the measuring line does not comprise a coaxial cable. In this case, the filling level measuring device can, for example, be tolerant of tolerance jumps in the process connection, i.e. of signal deviations that can be caused, for example, by an inconstant transmission of the electrical signal or the reflected signal. Advantageously, the costs are reduced by the use of a measuring line that does not comprise a coaxial cable. However, it should be noted here that the influenced electrical signal, and thus its processing, becomes more complex. After the application of the electrical signal, i.e. after an initial rising edge of the electrical signal, a reflection with the same polarity as the electrical signal results, which reflection is due to the measuring line, whereby the influenced electrical signal has an amplitude increase. After receiving the signal reflected at the medium surface, a drop in the influenced electrical signal is subsequently recorded, as already described in the above explanations. To be able to better evaluate the resulting influenced electrical signal by means of a comparator circuit, it can be differentiated beforehand. If the system is not multi-echo-capable, the impedance in the system must in particular be designed so that there are no reflections of the reflected signal back towards the process connection since these multiple reflections would impair the simple evaluation of the influenced electrical signal by means of the comparator circuit.

According to one embodiment, the electrical signal comprises a plurality of square pulses and the influenced electrical signal comprises a plurality of pulses, in particular pulses of the same kind, wherein the evaluation unit is configured to determine a DC component of the influenced electrical signal, and to determine the filling level of the medium based on the DC component of the influenced electrical signal. In particular, the individual square wave pulses can be assigned to individual different measurements. The width of a square wave pulse can, for example, be designed such that the pulse width of the associated pulse of the influenced electrical signal can be clearly determined. In other words, the individual square wave pulses are used as separate step functions that are applied to the system for a predefined time period, wherein the predefined time is defined by the width of the respective square wave pulse. The influenced electrical signal can, as already described above, be further processed by means of a comparator circuit. In the present case, the output signal of the comparator circuit would comprise a series of square wave pulses, wherein each square wave pulse of the output signal is to be assigned to a respective pulse of the influenced electrical signal and represents a respective measurement. In order to determine an average of the measurements, the DC component of the output signal of the comparator can, for example, be determined by means of a low-pass filter. A particularly advantageous embodiment is in this respect the use of a simple low-pass filter whose output signal is digitized by means of an ADC so that the DC component can be determined digitally. For example, the DC component can be determined by calculating a Fourier transform of the digitized signal at 0 Hz, which in particular corresponds to a moving averaging of the time signal. The mean value can thus be determined using simple, inexpensive hardware.

Alternatively, a plurality of individual filling level measurements can be determined according to one of the above embodiments and a mean value of the individual determined filling levels can be calculated to determine a final filling level value.

According to one embodiment, the signal generating device is configured to generate the square wave pulses of the electrical signal at variable time intervals. It should hereby be ensured that coherent EMC interference, which cannot be suppressed by a multiple measurement and a subsequent averaging, is compensated for. In other words, the generation of the square wave pulses does not take place according to a fixed transmission period, but can be generated randomly or according to another non-periodic pattern. For example, the time interval between two consecutive square wave pulses can be randomly selected from a time interval that includes time interval values between a minimum time interval and a maximum time interval. With the proposed evaluation or processing by means of a comparator, the processing of an aperiodic signal is possible in a particularly simple manner since the associated evaluations can be realized asynchronously and do not have a fixed clock reference to the electrical signal. Consequently, the emission of the system can be further reduced.

According to a further embodiment, the reference impedance is greater, in particular 5 times, 10 times, 12 times or 15 times greater, than the medium impedance. In particular, the reference impedance can be adapted to the medium impedance such that as strong as possible a reflection of the electrical signal takes place at the medium surface to be able to detect the corresponding reflection in a simple manner from the influenced electrical signal. If the medium is water, the reference impedance can, for example, be 50 Ohm, 60 Ohm or 75 Ohm.

In one embodiment, the measuring line is short-circuited at the end facing the medium. The short circuit is in particular located in the medium so that, when the reflection at the medium boundary is not complete, a residual portion or a residual wave of the electrical signal is reflected at the short circuit. If, in the influenced electrical signal, an influencing of the electrical signal can only be recognized by the reflection due to the short circuit, wherein in particular the influence of the reflection, which is due to the short circuit, on the electrical signal is known, it can be determined that the filling level is below the detection range. Furthermore, based on the influenced electrical signal, it can be ruled out that a defect of the sensor exists.

According to one embodiment, the measuring line, in particular as a coplanar line or a microstrip line, is arranged together with the evaluation unit and the signal generating device on the same circuit board. The filling level measuring device can thus be formed as very compact and can be inexpensive to manufacture. This is in particular advantageous for the use in smaller tanks. The filling level measuring device can in particular be configured such that the electronic components, with the exception of the measuring line, are protected from water, for example by means of a grouting, in a corresponding housing so that the filling level measuring device can be accommodated directly in the container.

A further aspect of the invention relates to a method for determining a filling level of a medium in a container, comprising the steps:
generating an electrical signal, which has a step function or a pulse function, by means of a signal generating device,
conducting the electrical signal via a measuring line into the container and towards the medium, wherein the measuring line extends from a process connection up to and into the medium,
reflecting at least a portion of the electrical signal from the surface of the medium, wherein the reflected signal influences the electrical signal, and
determining the filling level of the medium based on the influenced electrical signal by means of an evaluation unit.

According to one embodiment, the electrical signal is conducted with a substantially constant basic impedance. The filling level measuring device can, for example, be configured such that the basic impedances of the electrical components are approximated to one another. In particular, the electrical signal or the reflected signal is conducted along the measuring line with a substantially constant basic impedance. As already described, this can be achieved by means of a coaxial cable.

The statements on the filling level measuring device according to the invention apply accordingly to the method. This in particular applies with respect to advantages and embodiments.

It should be noted that any combination of the above embodiments is possible as long as this has not been explicitly excluded.

The invention will be presented purely by way of example with reference to the drawings in the following. There are shown:

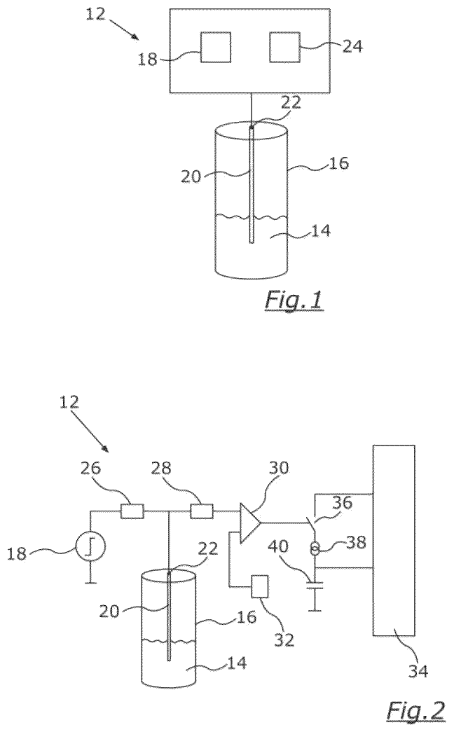

FIG. 1 a schematic representation of a filling level measuring device;

FIG. 2 a detailed schematic representation of a filling level measuring device;

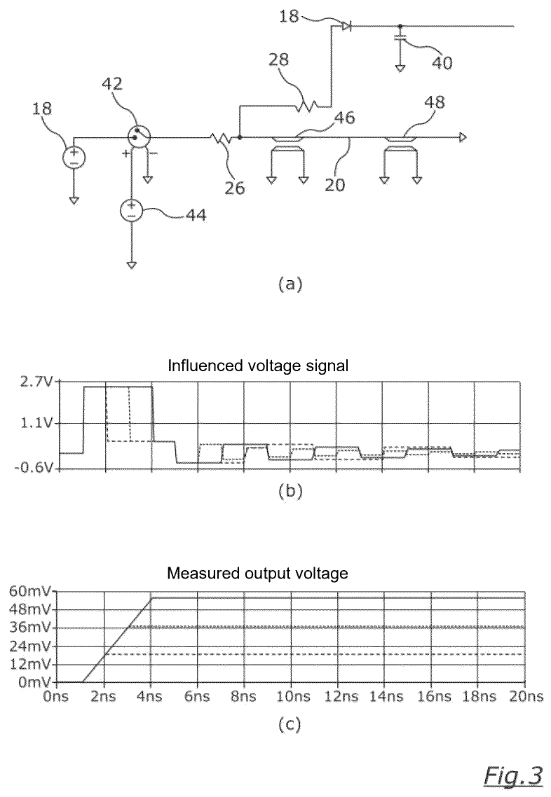

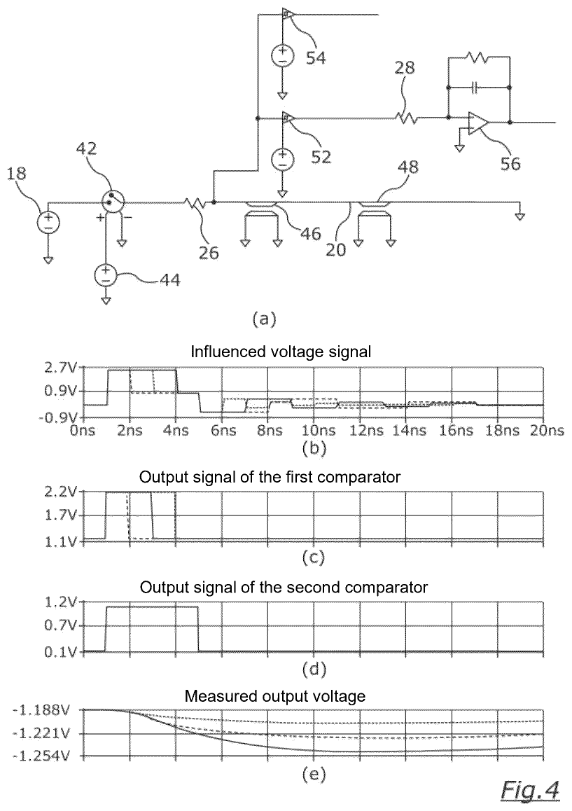

FIG. 3 a circuit diagram of a filling level measuring device (a), an influenced electrical signal for different filling levels (b) and the associated output voltages (c);

FIG. 4 a circuit diagram of a filling level measuring device (a), an influenced electrical signal for different filling levels (b), an output signal of a first comparator for the different filling levels (c), an output signal of a second comparator for the different filling levels (d) and the associated output voltages (e);

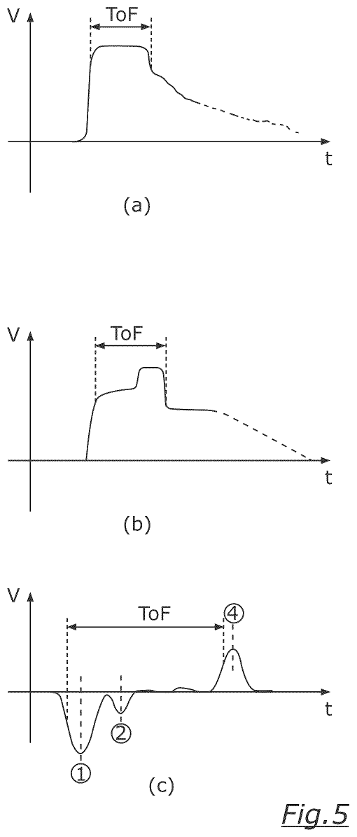

FIG. 5 a representation of the step response for a filling level measuring device with a coaxial cable (a) and for a filling level measuring device without a coaxial cable (b) as well as the representation of a pulse response (c);

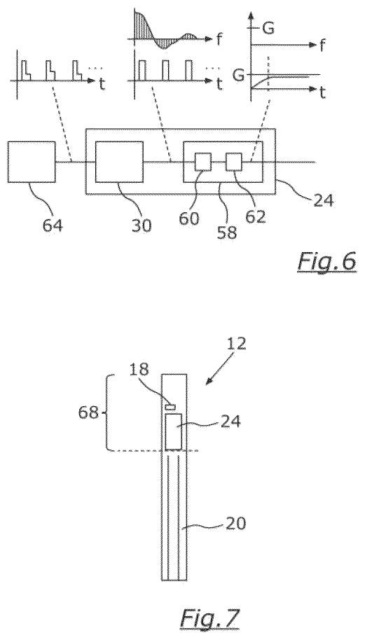

FIG. 6 a schematic representation of an evaluation unit for processing a plurality of level measurements; and

FIG. 7 an embodiment of the filling level measuring device.

FIG. 1 shows a schematic representation of a filling level measuring device 12 for determining a filling level of a medium 14 in a container 16. The filling level measuring device 12 comprises a signal generating device in the form of a voltage source 18 that is configured to generate an electrical signal, i.e. a voltage signal, that comprises a step function or a pulse function. The filling level measuring device 12 further comprises a measuring line 20 that is connected, in particular electrically, to the voltage source 18 and that extends from a process connection 22 up to and into the medium 14, wherein the measuring line 20 serves to conduct the voltage signal into the container 16 and towards the medium 14, the voltage signal is at least partly reflected at the surface of the medium 14 and the reflected signal influences the voltage signal. The filling level measuring device 12 furthermore comprises an evaluation unit 24 that is configured to determine the filling level of the medium 14 based on the influenced voltage signal.

FIG. 2 shows a detailed schematic representation of the individual components of the filling level measuring device 12. The voltage source 18 of the filling level measuring device 12 in this respect generates a voltage signal in the form of a step function. The voltage signal is applied to the measuring line 20 via a first resistor 26 and the process connection 22. In particular, the voltage wave of the voltage signal generated by the voltage source 18 runs via the first resistor 26 to the process connection and via a second resistor 28 to a comparator 30. There may be a discontinuity in the impedance development at the process connection 22 if the impedance of the circuit at the interface to the measuring line differs from the impedance of the measuring line 20, in particular the reference impedance 46. Preferably, the impedance of the circuit and the reference impedance 46 are approximated to one another so that there is no discontinuity or impedance jump at the process connection 22. The voltage wave therefore travels from the process connection 22 via the measuring line 20 to the medium 14 and, on reaching the medium surface, is reflected by the medium surface so that a reflected signal is produced that travels from the medium surface towards the process connection 22.

The reflection of the voltage wave is caused by the impedance difference between the impedance of the measuring line outside the medium 14, i.e. the reference impedance 46, and the impedance of the measuring line 14 inside the medium, i.e. the medium impedance 48. The stronger or greater the impedance difference, the more pronounced the reflection of the voltage wave is. The reflection of the voltage wave, i.e. the reflected signal, influences the voltage signal in that the reflected signal leads to a drop in the voltage signal. The influenced voltage signal, which is in particular present at the input of the comparator 30, is further processed by the comparator 30 in order to extract information from the influenced voltage signal, with which information the filling level of the medium 14 in the container 16 can be determined. For this purpose, the comparator 30 compares the influenced voltage signal with a predefined comparison voltage that is generated in the present case by a digital-to-analog converter (DAC) 32 that can be configured as part of a microcontroller 34. The comparison voltage of the comparator 30 can in particular be variable and can be reduced or increased continuously or at predetermined intervals by means of the DAC 32.

As already described, the reflected signal influences the voltage signal by causing a drop in the voltage. The level of the voltage drop in this respect depends on the level of the impedance difference between the reference impedance 46 and the medium impedance 48. If the reference impedance 46 is, for example, 10 times greater than the medium impedance 48, this leads to a drop in the original voltage of up to 90%. Based on this knowledge, the comparison voltage of the comparator 30 can be defined such that the output signal of the comparator 30, which is a square wave signal, depicts the rising edge of the influenced voltage signal and the falling edge of the influenced voltage signal, said falling edge caused by the reflected signal. For example, with a voltage drop of 90% caused by the reflected signal, the comparison voltage can be set to a voltage value of 20% of the initial voltage signal. The width of the square wave signal output by the comparator 30 then corresponds to the time of flight of the voltage wave from the process connection to the medium surface and back. The output signal of the comparator 30 has a voltage value Vhigh for all the values of the influenced voltage signal that are greater than the predefined comparison voltage and a voltage value Vlow or a voltage value of 0 V for all the values of the influenced voltage signal that are less than the predefined comparison voltage. Based on the output signal of the comparator 30, a current source 38 is then controlled via a switch 36 and charges an output capacitor 40 for the time period defined by the square wave signal. The voltage drop across the output capacitor 40 is in this respect proportional to the time of flight of the voltage wave from the process connection 22 to the medium surface and back or is indirectly proportional to the filling level of the medium 14 in the container 16. Accordingly, based on a measurement of the voltage of the output capacitor 40, the filling level of the medium 14 in the container 16 can be inferred. The time measurement, i.e. the measurement of the time of flight of the voltage wave, was thus converted into a voltage measurement. The measurement or detection of the voltage of the output capacitor 40 can, for example, take place by a corresponding ADC 62, not shown, of the microcontroller 34.

FIG. 3(a) shows a circuit diagram of the filling level measuring device 12. In this respect, via a fast switch 42, the voltage signal of the voltage source 18 is abruptly applied to the measuring line 20 via the first resistor 26. The switch 42 is moved into the closed or open position via a pulse generator 44. By alternately switching the switch 42 on and off, a sequence of square wave pulses can thus be generated. As already described above, a voltage wave of the voltage signal can be conducted via the measuring line 20 to the medium 14, wherein the measuring line 20 outside the medium 14 has an associated reference impedance 46, whereas the measuring line 20 inside the medium 14 has an associated medium impedance 48. Due to the impedance difference between the reference impedance 46 and the medium impedance 48, a reflection of the voltage wave back to the process connection takes place, which causes a voltage drop in the voltage signal. The influenced voltage signal can be used to charge an output capacitor 40 and, as a result, to infer the filling level of the medium 14 in the container 16. In the present embodiment, instead of the comparator 30 described above, a diode 50 is used to define a voltage threshold value and to generate the square wave signal that has a width corresponding to the time of flight of the voltage wave.

FIG. 3(b) shows the influenced voltage signal tapped at the input of the diode 18. As can be seen from the graph, after an initial steep rise, the voltage signal again drops to a value that corresponds to approximately 20% of the initial voltage value, wherein the voltage drop is caused by the reflected signal. Further drops or rises of the influenced voltage signal, which can be seen from the graph in FIG. 3(b), are due to further reflections of the voltage wave. However, in order to determine the time of flight of the voltage wave and thus the filling level of the medium, in particular the time of the first falling edge is relevant. Accordingly, the diode 50 is set such that the comparison voltage is greater than 20% of the output voltage value of the voltage source 18 so that the resulting square wave signal has a width that is equal to the width of the influenced voltage signal from a first rising edge up to a first falling edge. In the present case, the comparison voltage of the diode is 30% of the switch-on voltage of the voltage source 18. The influenced voltage signal is shown in accordance with FIG. 3(b) for different filling levels. The filling levels comprise a first, a second and a third filling level, wherein the first filling level is higher than the second filling level and the second filling level is higher than the third filling level. As can be seen in FIG. 3(b), the drop in the voltage signal for the first filling level takes place earliest due to the shorter time of flight of the voltage wave. Accordingly, the drop in the voltage signal for the second filling level takes place earlier than for the third filling level.

FIG. 3(c) shows a development of the output capacitor voltage for the different filling levels. As can be seen, the voltage of the output capacitor 40 increases linearly for the duration during which the square wave signal has a voltage value _{Vhigh}. As soon as the square wave signal drops back to the value 0V, the output capacitor 40 is no longer charged and stagnates at the voltage level reached. As can be seen from FIG. 3(c), the voltage value drop across the output capacitor 40 is higher for lower filling levels than for higher filling levels. This is due to the fact that the charging time of the output capacitor ideally corresponds to the time of flight of the voltage wave and is thus greater for lower filling levels than for higher filling levels.

FIG. 4(a) illustrates a circuit diagram of a filling level measuring device 12. In contrast to the circuit diagram of FIG. 3(a), the filling level measuring device 12 comprises a first comparator 52 and a second comparator 54. A further difference is that, instead of an output capacitor 40, an operational amplifier 56 is used to integrate the square wave signal generated by the first comparator 52. In this embodiment, however, the integrated value must be tapped directly since no storage of the signal value takes place as with the output capacitor 40. The first comparator 52 compares, as already explained above, the influenced voltage signal that is shown in FIG. 4(b) with a comparison voltage that is greater than the voltage value of the influenced voltage signal after a first voltage drop induced by the reflected signal. The output signal of the comparator thus simulates the first rising edge and the first falling edge of the influenced voltage signal, as can be seen in FIG. 4(c). The second comparator 54, on the other hand, is set so that its comparison voltage is lower than the voltage level after a first drop in the influenced voltage signal, but higher than the voltage level of the influenced voltage signal after a second drop that is, for example, caused by further reflections. The hereby generated signal, i.e. the output signal of the second comparator 54, is shown in FIG. 4(d). Additional comparators can thus be used to capture a plurality of reflections and thus to create a multi-echo capable system. A further processing of the output signal of the second comparator 54 is not provided in FIG. 4(a). In principle, however, the output signal of the second comparator 54 can be processed in the same way as the output signal of the first comparator 52, for example by means of a corresponding operational amplifier in the present case. The output signal of the operational amplifier 56 is shown in FIG. 4(e), wherein a voltage signal with a higher magnitude, as already shown in FIG. 3(c), indicates a lower filling level and thus a longer time of flight of the voltage wave.

In FIG. 5(a), the influenced voltage signal, i.e. the step response, for a step function is shown sketched as an input voltage signal when the filling level measuring device 12 is equipped with a coaxial cable as the measuring line 20. The influenced voltage signal has a pulse shape that is characterized by a rising edge when generating the electrical signal and by a falling edge when receiving the reflected signal. The pulse width in this respect corresponds to the time of flight of the voltage wave.

In FIG. 5(b), the influenced voltage signal, i.e. the step response, for a step function is shown sketched as an input voltage signal when the filling level measuring device 12 is not equipped with a coaxial cable as the measuring line 20. After applying the voltage signal, i.e. the rising edge of the voltage signal, a reflection attributable to the measuring line 20 with the same polarity as the voltage signal results, whereby the influenced voltage signal has an increase in amplitude. After receiving the signal reflected at the medium surface, a drop in the influenced voltage signal can then be recorded.

In FIG. 5(c), the influenced voltage signal, i.e. the pulse response, for a pulse function is shown sketched as an input voltage signal. As can be seen, an input pulse is applied that can be recognized as a reflected pulse in the influenced voltage signal after a corresponding time of flight. It is advantageous for the use of a pulse function as an input voltage signal that, as expected, media with small dielectric constants can be detected even if the amplitude of the reflected pulse is reduced in these cases. Furthermore, small impedance differences between the medium impedance 48 and the reference impedance 46 can be detected.

FIG. 6 shows a schematic representation of an evaluation unit 24 for processing a plurality of filling level measurements. The evaluation unit 24 comprises a comparator 30 and a mean value calculation unit 58, which comprises a low-pass filter 60 and an analog-to-digital converter (ADC) 62, and receives the influenced voltage signal via a preprocessing circuit 64 that comprises, among other things, the voltage source 18 and the measuring line 20. The voltage signal, which is generated by means of the voltage source 18, was periodically switched on and off or periodically connected to and disconnected from the voltage source 18 via the fast switch 42 in the present case so that the output signal, i.e. the uninfluenced voltage signal, comprises a plurality of square wave pulses. Each square wave pulse can in this respect be assigned to a respective measurement. Accordingly, the voltage signal influenced by the reflected signal likewise has a pulse shape that is shown sketched in FIG. 6. A respective pulse of the influenced voltage signal in this respect has a first rising edge that is attributable to a respective switching on of the voltage by the fast switch 42 and that leads to an increase in the voltage to a first voltage level; a first falling edge that is caused by the reflected signal and which leads to a drop in the voltage to a second voltage level; and a second falling edge that is caused by further reflections of the voltage signal or the voltage wave and/or by the disconnection of the voltage by the fast switch 42 and that leads to a drop in the voltage to an output level or a zero level.

The influenced voltage signal is further processed by means of the comparator 30, wherein the comparison voltage of the comparator 30 is set such that it is greater than the second voltage level. The signal components after the first drop in the influenced voltage signal are thus filtered out so that the signal remains that is output by the comparator 30 and that comprises a sequence of square wave pulses.

The individual pulses of the output signal of the comparator 30 can in this respect be assigned to a respective measurement. The individual pulses of the output signal of the comparator 30 can differ from one another, at least slightly, in their width and also in their amplitude. To improve the accuracy of the overall measurement, it is therefore advantageous to calculate a mean value of the individual measurements. For this purpose, a mean value of the individual measurements can be determined by means of the mean value calculation unit 58. This can take place particularly simply by determining the DC component G of the pulse-shaped output signal of the comparator 30. In this respect, the high-frequency signal components are removed by means of the low-pass filter 60 so that the output of the low-pass filter 60 mainly comprises the DC component G of the input signal. The signal can then be digitized by means of the ADC 62 and the DC component G can be determined digitally, for example, by determining a Fourier transform of the digitized signal at 0 Hz, which corresponds to a moving averaging of the time signal. The mean value can thus be determined by means of simple, inexpensive hardware.

FIG. 7 illustrates an embodiment of the filling level measuring device 12 in which the measuring line 20 is arranged together with the evaluation unit 24 and the voltage source 18 on the same circuit board 66. The filling level measuring device 12 can thus be formed as very compact and can be inexpensive to manufacture. The electronic components, with the exception of the measuring line 20, are protected against moisture in the upper part 68 of the filling level measuring device 12 by a grouting so that the filling level measuring device 12 can be accommodated directly in the container 16 of the medium 14. The measuring line 20 can, for example, be configured as a coplanar line or a microstrip line.

### REFERENCE NUMERAL LIST

12 filling level measuring device
14 medium
16 container
18 voltage source
20 measuring line
22 process connection
24 evaluation unit
26 first resistor
28 second resistor
30 comparator
32 digital-to-analog converter
34 microcontroller
36 switch
38 power source
40 output capacitor
42 fast switch
44 pulse generator
46 reference impedance
48 medium impedance
50 diode
52 first comparator
54 second comparator
56 operational amplifier
58 mean value calculation unit
60 low-pass filter
62 analog-to-digital converter
64 pre-processing circuit
66 circuit board
68 upper part of the filling level measuring device

1. A filling level measuring device for determining a filling level of a medium in a container, said filling level measuring device comprising:
a signal generating device that is configured to generate an electrical signal that comprises a step function or a pulse function;
a measuring line that is connected to the signal generating device and that extends from a process connection up to and into the medium, wherein the measuring line serves to conduct the electrical signal into the container and towards the medium, wherein the electrical signal is at least partly reflected at the surface of the medium and the reflected signal influences the electrical signal; and
an evaluation unit that is configured to determine the filling level of the medium based on the influenced electrical signal.

2. The filling level measuring device according to claim 1,
wherein the measuring line is electrically connected to the signal generating device.

3. The filling level measuring device according to claim 1,
wherein the evaluation unit is configured to determine a substitution variable based on the influenced electrical signal, said substitution variable being proportional to a time of flight of the electrical signal from the process connection towards the medium surface and back and/or to a distance between the medium surface and the process connection, and to determine the filling level of the medium based on the substitution variable,
wherein the substitution variable does not correspond to the time of flight of the electrical signal.

4. The filling level measuring device according to claim 3,
wherein the influenced electrical signal has a pulse shape,
wherein the evaluation unit is configured to generate a square wave signal based on a pulse width of a pulse of the influenced electrical signal, the width of said square wave signal substantially corresponding to the pulse width of the influenced electrical signal, and to determine the substitution variable based on the square wave signal.

5. A filling level measuring device according to claim 4,
wherein the evaluation unit is configured to generate a square wave signal based on a pulse width of a first pulse of the influenced electrical signal.

6. The filling level measuring device according to claim 4,
wherein the evaluation unit is configured, using a threshold value filter, to generate the square wave signal on the basis of the influenced electrical signal, wherein the square wave signal substantially assumes the value 0 if the influenced electrical signal is smaller than a predefined threshold value and assumes a predefined value not equal to 0 if the influenced electrical signal is greater than the predefined threshold value,
wherein the evaluation unit is configured to carry out an integration of the square wave signal using an integrator component in order to determine an integration value, and
to determine the filling level of the medium based on the integration value.

7. The filling level measuring device according to claim 6,
wherein the evaluation unit is configured to define the predefined threshold value in dependence on the impedance difference between a reference impedance, which represents the impedance of the measuring line for the section that does not extend into the medium, and a medium impedance that represents the impedance of the measuring line for the section that extends into the medium.

8. The filling level measuring device according to claim 6,
wherein the evaluation unit is configured to adjust the predefined threshold value of the threshold value filter continuously or at predefined time intervals.

9. The filling level measuring device according to claim 8,
wherein the evaluation unit is configured to reduce the predefined threshold value of the threshold value filter continuously or at predefined time intervals.

10. The filling level measuring device according to claim 6,
wherein the evaluation unit comprises a plurality of threshold value filters with different threshold values.

11. The filling level measuring device according to claim 6,
wherein the evaluation unit is configured to sample an integration signal, which is generated by the integration of the square wave signal, by means of an ADC with a sampling frequency of less than 10 MHz, less than 1 MHz, less than 100 kHz, less than 10 kHz or less than 1 kHz in order to determine the integration value.

12. The filling level measuring device according to claim 1,
wherein the measuring line comprises a coaxial cable.

13. The filling level measuring device according to claim 1,
wherein the electrical signal comprises a plurality of square pulses and the influenced electrical signal comprises a plurality of pulses,
wherein the evaluation unit is configured to determine a DC component of the influenced electrical signal, and
to determine the filling level of the medium based on the DC component of the influenced electrical signal.

14. The filling level measuring device according to claim 13,
wherein the influenced electrical signal comprises a plurality of pulses of the same kind.

15. The filling level measuring device according to claim 13,
wherein the signal generating device is configured to generate the square wave pulses of the electrical signal at variable time intervals.

16. The filling level measuring device according to claim 1,
wherein the reference impedance is greater than the medium impedance.

17. The filling level measuring device according to claim 16,
wherein the reference impedance is ar 5 times, 10 times, 12 times or 15 times greater than the medium impedance.

18. The filling level measuring device according to claim 1,
wherein the measuring line is arranged together with the evaluation unit and the signal generating device on the same circuit board.

19. The filling level measuring device according to claim 18,
wherein the measuring line is one of a coplanar line and a microstrip line.

20. A method for determining a filling level of a medium in a container, comprising the steps:
generating an electrical signal, which has the form of a step function, by means of a signal generating device,
conducting the electrical signal via a measuring line into the container and towards the medium, wherein the measuring line extends up to and into the medium,
reflecting a portion of the electrical signal from the surface of the medium, wherein the reflected signal influences the electrical signal, and
determining the filling level of the medium based on the influenced electrical signal by means of an evaluation unit.

21. The method according to claim 20,
wherein the electrical signal is conducted with a substantially constant basic impedance.
